(19) United States
(12) Patent Application Publication
(10) Pub. No.: US 2012/0270559 A1
(43) Pub. Date: Oct. 25, 2012

(54) TRACKING SYSTEM

(75) Inventor: David Craig Ingerson, Edens Landing (AU)

(73) Assignee: FIND-ME TECHNOLOGIES PTY LTD, Edens landing (AU)

(21) Appl. No.: 13/497,905

(22) PCT Filed: Sep. 24, 2010
(86) PCT No.: PCT/AU2010/001260

§ 371 Date: Jun. 4, 2012

(30) Foreign Application Priority Data
Sep. 25, 2009 (AU) 2009904671
Dec. 19, 2009 (AU) 2009906152

(51) Int. Cl. H04W 4/02

(52) U.S. Cl. 455/456.1

(57) ABSTRACT

A tracking system for tracking the location of an individual, the tracking system including a tracking device worn by the subject in use, the tracking device including a processor for determining a tracking device location and transferring location information indicative of the tracking device location to a base station via a communications network, the base station being for generating a location indication indicative of the tracking device location using the location information and providing the location indication to at least one user via a user end station and a communications network.

### BACKGROUND OF THE INVENTION

This invention relates to a tracking system for tracking the location of an individual, and in particular a tracking system including a tracking device for providing location information to a user via a communications network.

### DESCRIPTION OF THE PRIOR ART

Reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

It is said that Australia has one of the “oldest” populations in the western world. The elderly are the greatest users of the health system, so it is “an advantage” to provide care, “support” and “assistance” in the best possible way, with proper positive attitudes. It is quite normal for many people to live for 20 to 40 years after retirement, so it is essential that they are assisted to have a rich quality of life in the best health possible. This means independence, or near independence will be maintained.

In 2008, there were 227,300 people with dementia, and the number is expected to increase to 731,000 by 2050 unless there is a significant medical breakthrough. For example in Australia alone there were an estimated 57,000 new cases of dementia in 2008. Dementia can affect younger people, as well as older people, with currently over 9,600 Australians under the age of 65 have younger onset dementia.

Caring for people with dementia can be difficult, as they are often unaware that they have the condition, and can often become disorientated and confused, leading to them becoming lost. When this occurs, it is often necessary to launch a wide scale search, which is a drain on resources, such as the emergency services, and in some cases has lead to death in the event that the individual is not found. Accordingly, there is a need to provide a system for tracking individuals that is straightforward enough to allow this to be used for individuals suffering from dementia.

### SUMMARY OF THE PRESENT INVENTION

In a first broad form the present invention seeks to provide a tracking system for tracking the location of an individual, the tracking system including a tracking device worn by the subject in use, the tracking device including a processor for:
a) determining a tracking device location; and,
b) transferring location information indicative of the tracking device location to a base station via a communications network, the base station being for:
   i) generating a location indication indicative of the tracking device location using the location information; and,
   ii) providing the location indication to at least one user via a user end station and a communications network.

Typically the tracking device includes at least one input button, and wherein in response to actuation of the at least one input button, the processor is for:
a) initiating communication with at least one user end station;
b) transferring location information to the base station; and,
c) transferring status information to the base station.

Typically the tracking device includes at least one input button, and wherein in response to actuation of the at least one input button, the processor is for:
a) determining an action associated with the at least one input button using configuration data stored in a store; and,
b) performing the action in accordance with the configuration data.

Typically the tracking device is for:
a) receiving update instructions from at least one of the base station and a user end station; and,
b) updating configuration data in accordance with the function instructions.

Typically the processor is for:
a) receiving update instructions from a user end station;
b) determining if the user end station is authorised to update configuration data; and,
c) updating the configuration data in accordance with a successful determination.

Typically the processor is for transferring location information at least one of:
a) periodically;
b) in response to actuation of an input button; and,
c) in response to a location request from at least one of the base station and a user end station.

Typically the processor is for:
a) transferring the location information using a first communications process if the first communication process is available; and,
b) transferring the location information using a second communications process if the first communications process is not available.

Typically the first communications process includes transferring the location information to the base station using a data transfer protocol, and wherein the second communications process includes transferring the location information to a messaging gateway using a messaging protocol, the messaging gateway transferring the location information to the base station.

Typically the location information includes an indication of a tracking device identifier.

Typically the processor is for:
a) determining status information indicative of a device status; and,
b) transferring the status information to the base station, the base station being responsive to the status information to determine any actions required.

Typically the status information is indicative of:
a) received location requests;
b) input buttons actuated; and,
c) device operating parameters.

Typically the tracking device includes:
a) a body containing processing electronics; and,
b) a strap for attaching the body to the individual.

Typically the strap is lockable to prevent the tracking device being removed by the individual.

Typically the tracking device includes at least two input buttons.

Typically the at least two input buttons are electrically connected to a battery, the at least two input buttons forming electrical contacts to allow a current to be applied to the battery thereby charging the battery.

Typically the tracking device includes:
a) a location module for determining the tracking device location;
b) a communications module for communicating with at least one of the base station and a user end station; and,
c) a processing module including the processor for:
   i) determining the tracking device location from the location module; and,
   ii) transferring the location information to the base station using the communications module.

Typically the location module is a GPS module, and the location information includes latitude and longitude information.

Typically the communications module includes a cellular communications module.

Typically the tracking device includes a speaker and microphone for allowing voice communication using the communications module.

In a second broad form the present invention seeks to provide a tracking system for tracking the location of an individual, the tracking system including, a base station including a processor for:
a) receiving location information from a tracking device worn by the individual via a communications network, the location information being indicative of a tracking device location;
b) generating a location indication indicative of the tracking device location using the location information; and,
c) providing the location indication to at least one user via a user end station and a communications network.

Typically the location information is indicative of a latitude and longitude, and wherein the processor is for:
a) determining an address using the latitude and longitude; and,
b) generating the location indication using the address.

Typically the location indication includes a graphical representation of the address.

Typically the location information includes an indication of a tracking device identifier, and wherein the processor is for storing location data indicative of the tracking device location in a store using the tracking device identifier.

Typically the processor is for:
a) determining a recipient; and,
b) transferring the location indication to the recipient.

Typically the processor is for determining the recipient using at least one of:
a) tracking device data stored in a store;
b) a tracking device identifier; and,
c) status information received from the tracking device.

Typically the processor is for:
a) determining if a user is authorised to receive the location indication; and,
b) providing the location indication in response to a successful authorisation.

Typically the processor is for:
a) receiving status information from the tracking device; and,
b) at least one of:
   i) determining any actions required using status information; and,
   ii) storing the status information.

Typically the status information is indicative of:
a) received location requests;
b) input buttons actuated; and,
c) device operating parameters.

Typically the processor is for:
a) comparing at least one of status information and location information to defined criteria; and,
b) selectively providing at least one of location indication and a notification to a user end station in response to the results of the comparison.

Typically the base station is for:
a) determining update instructions; and,
b) transferring the update instructions to the tracking device, the tracking device being responsive to the update instructions to update configuration data.

Typically the base station is for determining update instructions in accordance with user input commands received from a user end station.

Typically the processor is for at least one of:
a) storing the location information in a store;
b) transferring the location indication to the user end station; and,
c) allowing the user end station to access a network page including the location indication.

In a third broad form the present invention seeks to provide a tracking system for tracking the location of an individual, the tracking system including:
a) a tracking device worn by the subject in use, the tracking device including a device processor for:
   i) determining a tracking device location; and,
   ii) transferring location information indicative of the tracking device location to a base station via a communications network; and,
b) a base station including a base station processor for:
   i) receiving location information from a tracking device worn by the individual via a communications network, the location information being indicative of a tracking device location;
   ii) generating a location indication indicative of the tracking device location using the location information; and,
   iii) providing the location indication to at least one user via a user end station and a communications network.

In a fourth broad form the present invention seeks to provide a method of tracking the location of an individual, the method including in a processor of a tracking device worn by the subject in use:
a) determining a tracking device location; and,
b) transferring location information indicative of the tracking device location to a base station via a communications network, the base station being for:
   i) generating a location indication indicative of the tracking device location using the location information; and,
   ii) providing the location indication to at least one user via a user end station and a communications network.

In a fifth broad form the present invention seeks to provide a method for use in tracking the location of an individual, the method including in a processor of a base station:
a) receiving location information from a tracking device worn by the individual via a communications network, the location information being indicative of a tracking device location;
b) generating a location indication indicative of the tracking device location using the location information; and,
c) providing the location indication to at least one user via a user end station and a communications network.

In a sixth broad form the present invention seeks to provide a method for tracking the location of an individual, the method including:
a) in a processor of a tracking device worn by the subject in use:
   i) determining a tracking device location; and,
   ii) transferring location information indicative of the tracking device location to a base station via a communications network; and,
b) in a base station processor:
   i) receiving location information from a tracking device worn by the individual via a communications network, the location information being indicative of a tracking device location;
   ii) generating a location indication indicative of the tracking device location using the location information; and,
   iii) providing the location indication to at least one user via a user end station and a communications network.

### BRIEF DESCRIPTION OF THE DRAWINGS

An example of the present invention will now be described with reference to the accompanying drawings, in which:

FIG. 1 is a schematic diagram of an example of a tracking device;

FIG. 2 is a schematic diagram of an example of a distributed communications system;

FIG. 3 is a schematic diagram of an example of a processing system;

FIG. 4 is a schematic diagram of an example of an end station;

FIG. 5 is a flow chart of an example process for tracking the location of an individual;

FIGS. 6A and 6B are flow charts of a second example of a process for tracking an individual;

FIG. 7 is a flow chart of an example process for accessing location information;

FIG. 8A is a schematic diagram of a user interface used for accessing location information;

FIG. 8B is a schematic diagram of a second user interface used for accessing location information;

FIGS. 9A and 9B are flow charts of an example process for updating tracking device settings;

FIG. 10 is an example of a user interface for use in updating tracking device settings;

FIGS. 11A to 11E are schematic diagrams illustrating example uses of the tracking device;

FIGS. 12A and 12B are images of an example tracking device.

### DETAILED DESCRIPTION OF THE PREFERRED EMBODIMENTS

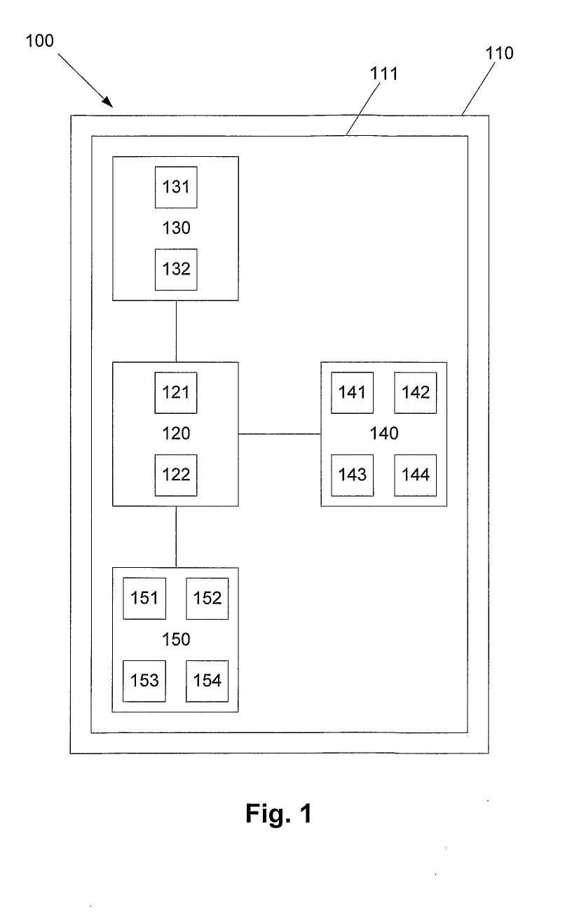

An example of a tracking device will now be described with reference to FIG. 1.

In this example the tracking device 100 includes a body 110 containing processing electronics 111, such as a processing module 120, a location module 130, a communications module 140 and an input/output module 150.

In use, the body 110 is typically adapted to be worn by an individual, for example through the provision of a strap, or the like, which allows the body to be worn in a fashion similar to a wrist-watch. However, any alternative means of allowing the tracking device 100 to be worn could be used, such as integrating the body 110 into an article of clothing, providing a clip allowing the body to be attached to clothing, or the like.

In use, the location module 130 is adapted to determine the location of the tracking device 100. To achieve this, the location module 130 typically includes an antenna 131 and location processor 132, which operates to detect and interpret signals received via the antenna 131, allowing the location of the tracking device 100 to be determined. It will be appreciated that the location module 130 can be a GPS (Global Positioning System) module, or similar. Accordingly, operation of the location module 130 will not be described in further detail.

Signals from the location module 130 are transferred to the processing module 120, which includes a processor 121 and a memory 122. The memory 122 typically holds instructions, which when executed by the processor 121 allows the processor 121 to perform programmed functionality, such as to interpret the signals from the location module 130 and determine a tracking device location as well as to determine status information relating to the operation of the device.

The processing module 120 is coupled to the communications module 140, which typically includes an antenna 141, a transceiver 142, a codec 143 and optionally removable media 144, such as a SIM card or the like. It will be appreciated that the communications module 140 can be of any suitable form but in one example includes a GPRS or other cellular communications module. The communications module 140 allows the processing module 120 to communicate with other devices, such as a base station, end station, or the like, via a communications network. This allows location and/or device status information to be transferred, as well as to allow updating of tracking device settings, as will be described in more detail below. In addition to this, the communications module 140 can be used to allow the tracking device 100 to function as a mobile phone, allowing voice calls to be received and/or made by the tracking device 100, as will be appreciated by persons skilled in the art.

The input/output module 150 typically includes a display 151, input buttons 152, speaker 153 and microphone 154. The input/output module 150 is coupled to the processing module 120 to allow information to be presented to the user via the display 151, such as status information, time and date information, details of notifications, or the like, as well as to allow actions to be performed in accordance with inputs provided by the input buttons 152. In addition to this, the speaker and microphone 153, 154 can be used to allow voice communications to be provided using the communications module 140.

Whilst separate modules are shown in the above example, this is for the purpose of illustration only, and is not intended to be limiting. Accordingly, it will be appreciated that the modules could be notional functional modules, with the functionality being provided by a single suitably configured processor.

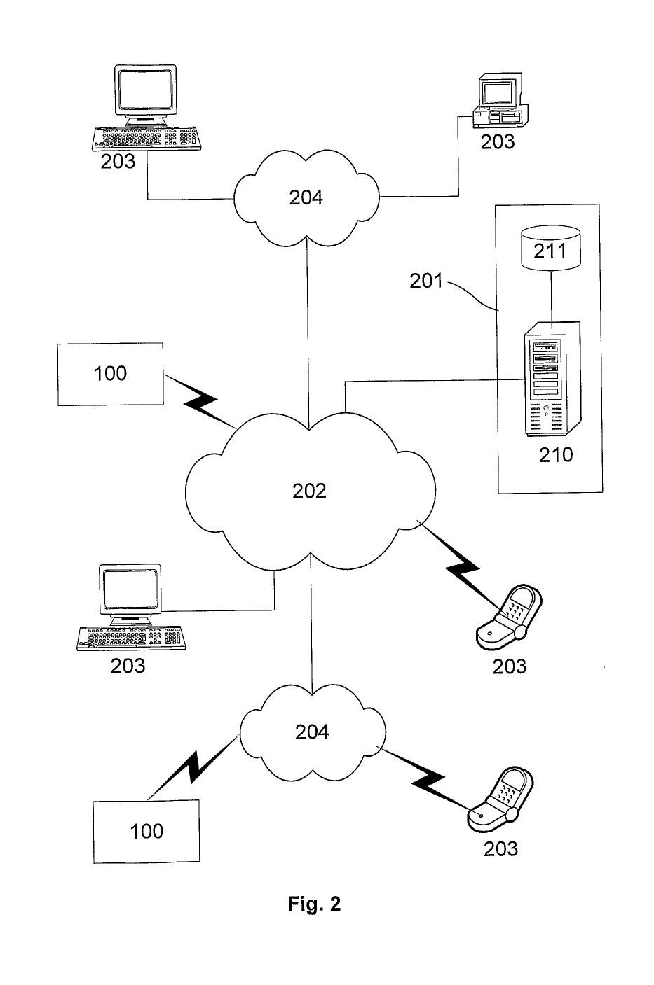

In any event, the above described tracking device 100 can be attached to an individual to allow location information to be provided to a remote device using the communications network. The tracking device is therefore typically used in a communications network environment, an example of which will now be described with reference to FIG. 2.

In this example, a base station 201 is coupled via a communications network 202, such as the Internet, cellular phone network, or the like, and/or a communications networks, such local area networks (LANs) 204, to a number of end stations 203, as well as a number of tracking devices 100.

In use, the base station 201 includes one or more processing systems 210 that are used in monitoring the tracking device 100, determining a tracking device location, and then providing location indications to users of the end stations 203.

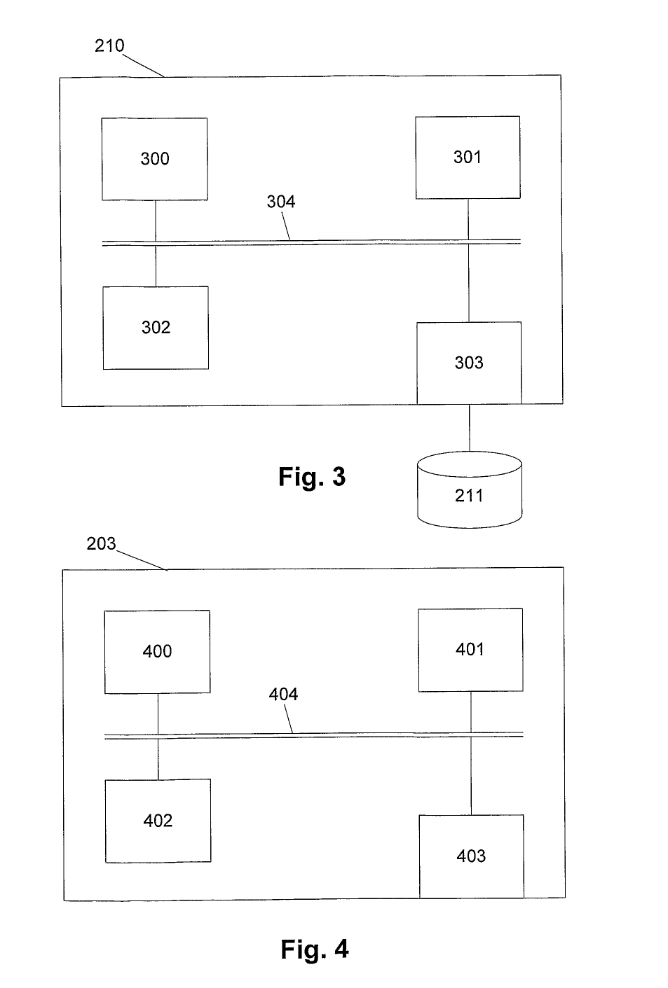

An example of a suitable processing system 210 is shown in FIG. 3. In this example, the processing system 210 includes at least one processor 300, a memory 301, an input/output device 302, such as a keyboard and/or display, and an external interface 303, interconnected via a bus 304 as shown. In this example the external interface 303 can be utilised for connecting the processing system 210 to peripheral devices, such as the communications networks 202, 204, databases 211, other storage devices, or the like. Although a single external interface 303 is shown, this is for the purpose of example only, and in practice multiple interfaces using various methods (eg. Ethernet, serial, USB, wireless or the like) may be provided.

In use, the processor 300 executes instructions in the form of applications software stored in the memory 301 to allow the tracking process to be performed, or to provide access to any data required by the end stations 203. Accordingly, it will be appreciated that the processing system 300 may be formed from any suitable processing system, such as a suitably programmed computer system, PC, web server, network server, or the like.

As shown in FIG. 4, in one example, the end station 203 includes at least one processor 400, a memory 401, an input/output device 402, such as a keyboard and/or display, and an external interface 403, interconnected via a bus 404 as shown. In this example the external interface 403 can be utilised for connecting the end station 203 to peripheral devices, such as the communications networks 202, 204, databases 211, other storage devices, or the like. Although a single external interface 403 is shown, this is for the purpose of example only, and in practice multiple interfaces using various methods (eg. Ethernet, serial, USB, wireless or the like) may be provided.

In use, the processor 400 executes instructions in the form of applications software stored in the memory 401 to allow communication with the base station 201, for example to allow the end station 203 to receive and display location indications and other notifications. Accordingly, it will be appreciated that the end stations 3 may be formed from any suitable processing system, such as a suitably programmed PC, Internet terminal, lap-top, hand-held PC, mobile phone, or other communications device, which is typically capable of operating applications software. Additionally, and/or alternatively, the end station 203 may be capable of allowing direct communication with the tracking device 100, for example if the end station 203 is a mobile phone, smart phone, or the like.

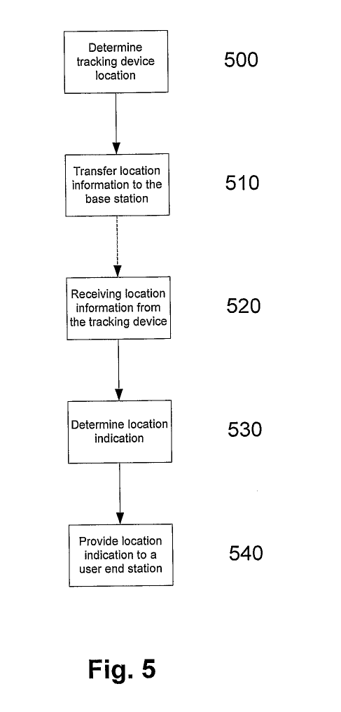

An example process for tracking an individual will now be described with reference to FIG. 5.

In this example, at step 500 a tracking device location is determined by the tracking device 100. This typically involves having the location module 130 transfer an indication of the location to the processing module 120 in the form of latitude and longitude information. Determination of the tracking device location can be performed in response to a number of different events. For example, this can be performed on a periodic basis in accordance with a preset time period, stored for example as part of settings defined in configuration data in the memory 122. Alternatively, this can be performed in response to actuation of input selected input buttons 152, or in response to a location request received from either the base station 201 or an end station 203, as will be described in more detail below.

At step 510 location information is transferred to the base station 201. This is typically achieved by having the processor 121 generate a data packet including the location information and other optional information, such as a tracking device identifier and/or status information. The processor 121 then forwards this data packet to the communication module 140 allowing this to be transferred to the base station 201 via an appropriate communications protocol.

At step 520 the processing system 210 receives the location information from the tracking device 100 and uses this to determine a location indication at step 530. This may be achieved in any appropriate way but typically involves having the processing system 210 interpret the location information, such as longitude and latitude information, and determine a street address. The street address is typically easier for users of the system to interpret and hence find, thereby allowing tracking of individuals to be performed fax more easily than can be otherwise achieved if only latitude or longitude information is provided. The processing system 210 may also optionally store the location information in a store, such as the database 211.

At step 540 the location indication is provided to a user of an end station 203. This can be performed in any one of a number of ways depending on the circumstances. For example, the location indication could be transferred to the end station using a communications protocol, such as SMS, MMS, email, instant messenger, or the like. This could be performed upon request, on a periodic basis, or if certain criteria are met or exceeded, such as if the individual strays outside a pre-set region. Alternatively, a user of the end station 203 may log into a website or similar, to access the location indication via a webpage, as required.

It will be appreciated from the above that the tracking device 100 can be worn by individuals that are at risk of becoming lost. The tracking device 100 can be used to automatically provide a tracking device location, allowing an indication of this to be provided to users of the system as required. This allows third party users, such as friends, relatives, emergency services, care workers, or the like, to keep track of the individual's location and find them in the event that they go missing. In this instance, by providing location indications in the form of a street address, this makes locating missing individuals a straightforward process.

Furthermore, by having the location indications provided by a base station 201, this allows access to the location indications to be achieved using a variety of techniques, thereby ensure that easy access to the information is available in a wide range of circumstances.

Additionally, the base station 201 can be used to monitor status information generated by the tracking device 100, and generate notifications in the event that the criteria are met or exceeded. This allows notifications to be provided as required, for example if the individual strays outside a predefined region or exceeds a certain speed limit, if the tracking device 100 is not operating correctly, or the like.

A further application is that the tracking device 100 can include input buttons 152, which in one example can be programmed to perform different actions, such causing a notification to be provided to users, should this be required. For example, in the event that the individual becomes disorientated or lost they may press an alert button which generates a notification informing users of the system that the individual is lost and requires attention.

It will be appreciated that whilst this finds particular use with the cognitively impaired, such as individuals suffering from dementia or the like, it also has wide use in a range of other circumstances. For example it can be used to track individuals working in hazardous environments, such as military, emergency services, or the like, as well as to track children, or other vulnerable individuals.

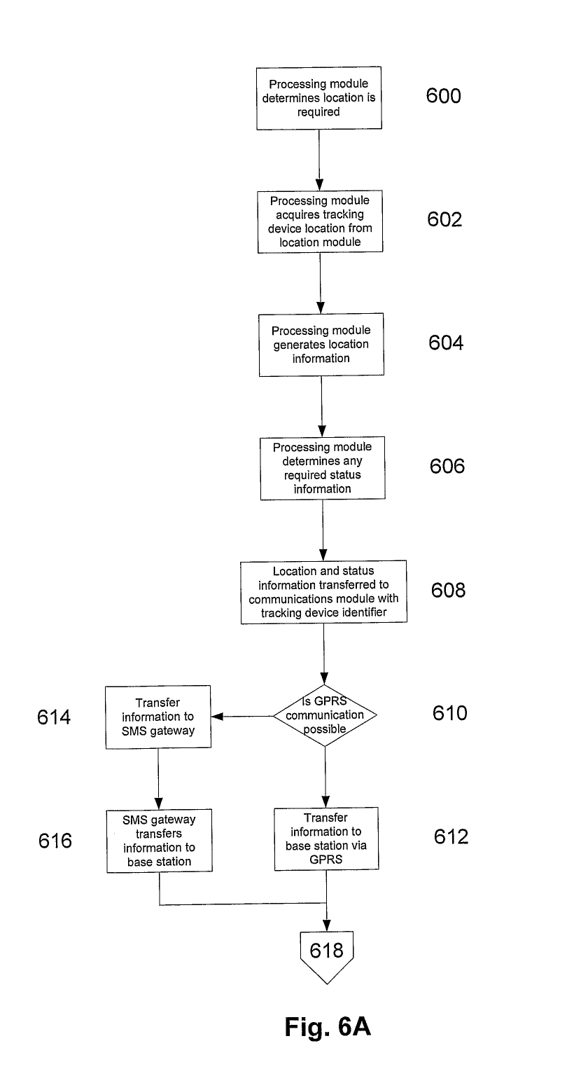

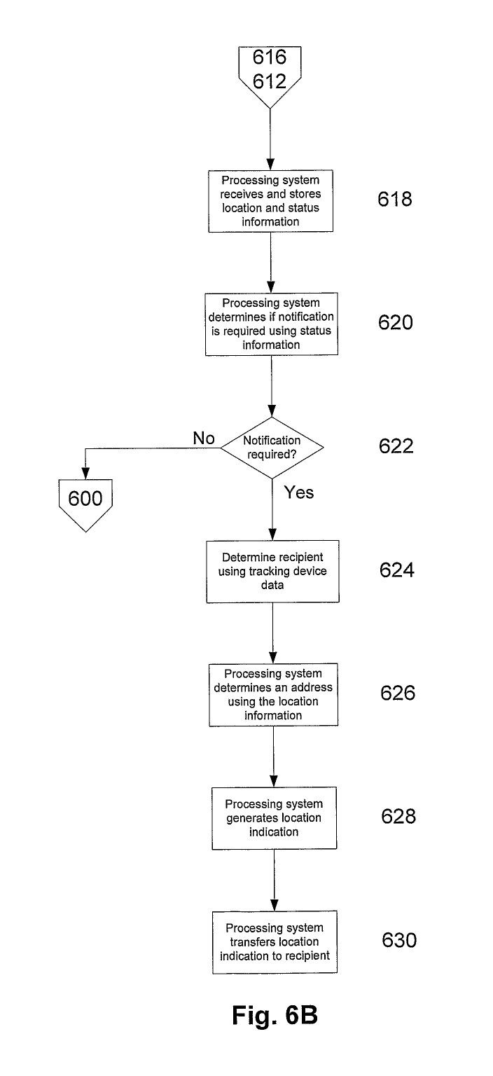

An example process for tracking the location of an individual will now be described in more detail with reference to FIGS. 6A and 6B.

For the purpose of this example, it is assumed that the base station 201, and in particular a processing system 210, executes applications software for handling location requests, providing location indications and notifications, as well as allowing users to interact with tracking device data, through appropriate user interfaces, such as webpages. The end stations 203 are used for viewing location indications, generating location requests, and otherwise interacting with the processing system 210, for example to view user interfaces, such as webpages. It will be assumed that actions performed by the processing system 210 are performed by the processor 300 in accordance with instructions stored as applications software in the memory 301 and/or input commands received from a user via the I/O device 302. Similarly, it will be assumed that actions performed by the end station 203 are performed by the processor 400 in accordance with instructions stored as applications software in the memory 401 and/or input commands received from a user via the I/O device 402.

In this example, at step 600 the processing module 120 determines that location information is required. This is typically performed in accordance with settings defined and stored in the memory 122 as configuration data. In one example, this is performed periodically, in accordance with the settings. Alternatively, this may be performed in response to an event, such as actuation of an input button 152, receipt of location requests from either the base station 201 or one of the end stations 203. In the case of actuation of an input button 152, the processing module 120 uses the configuration data to determine what action is required, and acts accordingly, for example to provide location information to the base station 201 allowing a location indication to be sent to a particular user end station 203. In the case of a location request, this can be received in any suitable way, such as via a GPRS, SMS message, or the like, as will be described in more detail below, with this being transferred to the processor 121 using the communications module 140.

At step 602 the processing module 120 acquires the tracking device location from the location module 130. This may be achieved in any suitable way but typically involves having the processor 121 request the information from the processor 131 of the location module 130, with an indication of latitude and longitude being provided in return.

At step 604 the processor 121 generates the location information using the latitude and longitude, for example by generating a data packet for transfer to the communication module 140. At step 606, the processor 121 determines if any status information is required. Status information can be provided to allow the base station 201 to determine various parameters regarding operation of the tracking device 100. This can include for example, details of received location requests and input buttons actuated, as well as other device operating parameters, such as battery strength, location signal strength, or the like.

At step 608 the location information and status information are transferred to the communications module 140, allowing these to be transferred to the base station 201, together with a tracking device identifier. The tracking device identifier allows different tracking devices to be uniquely identified, and is typically in the form of a phone number associated with the communications module 140, although other suitable identifiers such as an IP address, MAC (Media Access Control) address or the like, could be used.

At step 610 the processor 141 determines if a first communication option is available. The first communication option is typically a high speed, low cost, data transfer option, such as data packet transfer over a GPRS, EDGE, 3G network, or the like. In the event that first communication option is available, the location and status information and the tracking device identifier are transferred directly to the base station 201 using the first communication option, which in this example is GPRS communication.

In the event that the first communication option is not available, at step 614 a second communication option can be used. In this example, the location and status information are formatted as an SMS message and transferred to an SMS gateway, which can then forward this together with the tracking device identifier to the base station 201 at step 616.

It will be appreciated that this mechanism allows for multiple communications options to be exploited, depending for example on the availability of different communications networks. In this particular example, the ability to switch between GPRS and SMS communications means that location information can be sent even in scenarios where only minimal cellular network coverage is available. For example this allows information to be transmitted through SMS messages when a connection is available in a process known as breadcrumbing.

However, other techniques could be used, such as Wi-Fi connections, satellite connections, or the like.

At step 618 the processing system 210 receives and stores the location and any status information. The processing system 210 typically maintains a database of location and status data associated with each tracking device 100. This information can be stored on the basis of the tracking device identifier, as will be appreciated by a person skilled in the art. Maintaining a database in this manner allows tracking of an individual's movements to be performed. In particular, the location data can be reviewed to determine the location of the individual at any one of a number of times, for example to determine an individual's route and predict further movements.

At step 620 the processing system 210 determines if a notification of the location or status is required. This can be performed in any one of a number of ways, depending on the preferred implementation, but will typically involve comparing parameters in the status information to criteria that indicate if a notification is required.

The criteria are typically defined as part of a tracking device profile, stored as tracking device data in database 211. The tracking device data are therefore indicative of conditions that should result in the location indication being provided, and this can include for example, the actuation of one or more of the input buttons 152, if the tracking device location is outside of a defined region, if the tracking device speed exceeds a set level, or if device operating parameters, such as signal strength, or battery levels, fall outside acceptable ranges. The tracking device data can also specify users to which the location indications should be provided and how the information should be provided, for different circumstances. For example, this can indicate that a location indication is provided to different users using different defined techniques depending on which input button is pressed.

Thus, for example, if the status information indicates that a button has been actuated, the processing system 210 can access the tracking device data and determine an action associated with that button. This may specify for example, that a location indication and predetermined message, such as “The individual requires attention”, should be forwarded to a defined recipient end station 203 using SMS, email or the like.

The tracking device data may also be indicative of one or more device settings, as will be described in more detail below.

In any event, the processing system 210 accesses the tracking device data using the tracking device identifier, and uses this together with the status information to determine whether notification is required.

At step 622 if it is determined that notification is not required the process can return to step 600, allowing further location information to be determined. Otherwise at step 624 the processing system 210 determines a recipient, for example, using the tracking device data.

At step 626 the processing system 210 determines a street address using the location information, with the processing system 210 using this to generate the location indication. It will be appreciated that the nature of the location indication will vary depending on the preferred implementation, and on how the location indication is to be provided to the user. Thus for example, if the end station 203 is a normal mobile phone the location indication could be in the form of an SMS message. Alternatively, if the end station 203 is a computer system this may be in the form of an email, link to a website, or the like.

At step 628 the processing system 210 transfers the location indication to the recipient allowing them to view this. It will be appreciated that this will also include any relevant notification, such as an indication that the individual has strayed outside the defined region, an indication that the individual requires assistance, or the like.

Accordingly, it will be appreciated that the above described process allows the base station 201 to receive location and status information and interpret this using tracking device data to determine if a notification is required. In the event that notification is required, the location information, and other information can be transferred directly to user's end stations 201 in accordance with instructions defined in the tracking device data. As an alternative to the above, it will be appreciated that determination of the need for a notification can be performed directly by the tracking device 100 using the configuration data. In this instance, steps 620 to 624 are effectively performed in the tracking device, with the tracking device 100 indicating in the status information that the notification is required.

In any event, the use of the base station 201 allow the GPS location information to be interpreted into a more useful format, such as a street address and optional map, thereby making the location indication far more useful to end users. Additionally, the base station 201 can be used to generate notifications in response to specific events. These notifications can include the location indications, and can be made available to users in a range of predefined manners. This provides significant convenience for end users, allowing them to monitor the locations of individuals passively, whilst avoiding the need for an intermediate individual, such as a call centre operative, to notify the user if required.

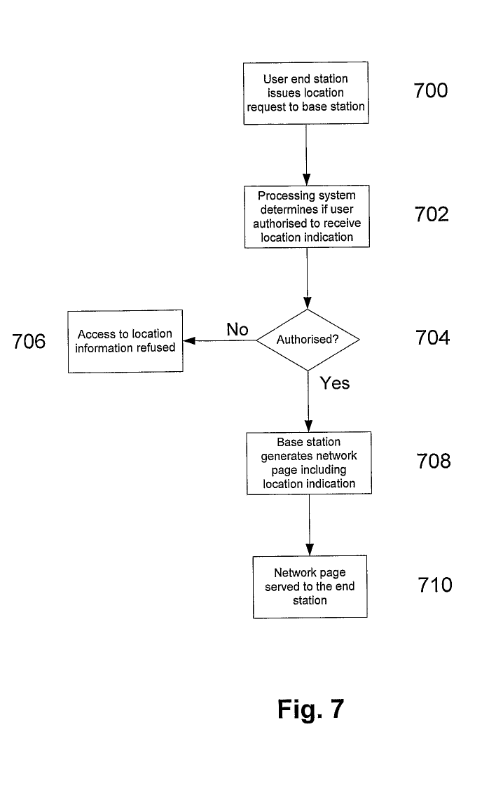

In addition to forwarding a location indication when a notification is required, location indications can also be accessed as desired by users of the end stations 203. An example of this will now be described with reference to FIG. 7.

In this example, at step 700, the user end station 203 issues a location request to the base station 201. This may be achieved in any number of manners depending on the preferred implementation. Thus, this could involve having the end station 203 generate an SMS at request which is transferred to the base station 201 via an intermediate SMS gateway. Alternatively, as will be described in this example, the user end station 203 executes a browser application, allowing the user to view a web page hosted by the base station 201. The user can then use the end station 203 to select an option to allow a location indication to be viewed.

As part of this process, the user will typically be requested to identify a relevant tracking device 100 for which the request is made, as well as provide relevant authorisation information, such as a user name and password or the like. At step 702, this information is used by the processing system 210 to determine if the user is authorised to receive a location indication for the respective tracking device 100. This will typically involve comparing the authorisation information, such as the user name and password, to a list of registered users stored in the database. The list will indicate the relevant authentication information for authorised users as well as the tracking devices 100 for which they are authorised to receive location information. Thus, for example, care workers and emergency services may be authorised to view the location of many devices, whilst general public users may only be able to view locations for friend's and relatives.

If the user is not authorised at step 704, then access to the location information is refused at 706 and an indication of the reason why may be provided to the user via the end station 203. If the user is authorised, at step 708 the processing system 210 generates a webpage including a user interface displaying the location indication, with this being served to the end station 203 at step 710.

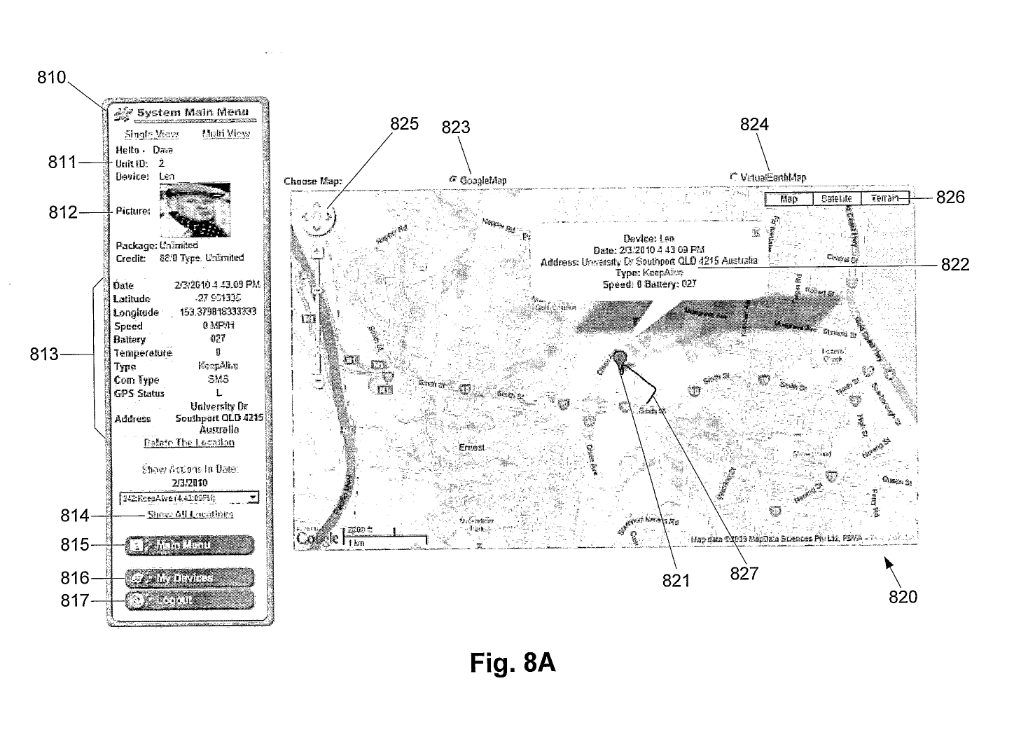

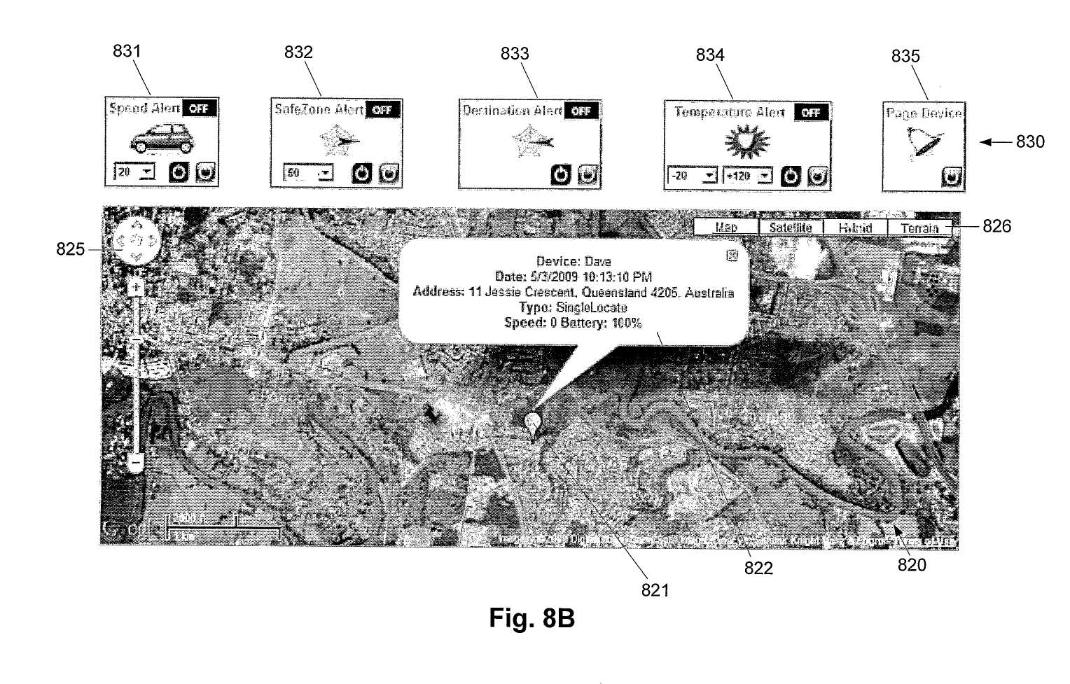

An example user interface is shown in FIG. 8A. In this example, the user interface 800 includes a main menu window 810, and a representation window 820.

The main menu window 810 can display a range of information and/or include a number of menu options. In this example, the main menu window 810 displays tracking device information 811, such as a tracking device name and identifier, as well as a picture 812 of the individual wearing the tracking device, and location and status information 813. This information can be used to assist users in locating the relevant individual wearing the tracking device, as will be appreciated by persons skilled in the art.

The location and status information can include details, such as time and date of the last location update from the tracking device, together with the corresponding latitude and longitude and address. In addition to this, the information can include a current speed, battery charge level, temperature, communication mechanism used for the last location update, or the like.

A show locations option 814 is provided allowing a user to select the locations being displayed in the representation window 820. In addition to this, main menu, my devices and logout options 815, 816, 817 are provided.

It will be appreciated that the menu options can be used to allow users to perform various actions, including requesting an updated location, generating an alarm on the tracking device indicative of a medical alert, updating authorised contacts, viewing a location history, updating settings, examining tracking device information, and logging out.

The representation window 820 presents a map showing the location of the individual 821, together with specific information such as the address 822. Options to select different representation types can also be displayed 823, 824, together with controls 825, 826 to allow the display of the map to be controlled as will be appreciated by persons skilled in the art. In addition to this, information regarding a recently travelled route may also be displayed 827.

As shown in the example of FIG. 8B, the user interface 800 can also be adapted to display input options 830, allowing the user to configure appropriate criteria used in assessing whether a notification is to be generated. The current example includes settings of a speed alert 831, a safezone alert 832, such as a predetermined region, a destination alert 833, and a temperature alert 834. However, it will be appreciated that other settings may also be defined and that the shown examples are for the purpose of illustration and are not intended to be limiting. Finally, a page device input 834 may be included to allow the tracking device to be paged to update the location and/or status information.

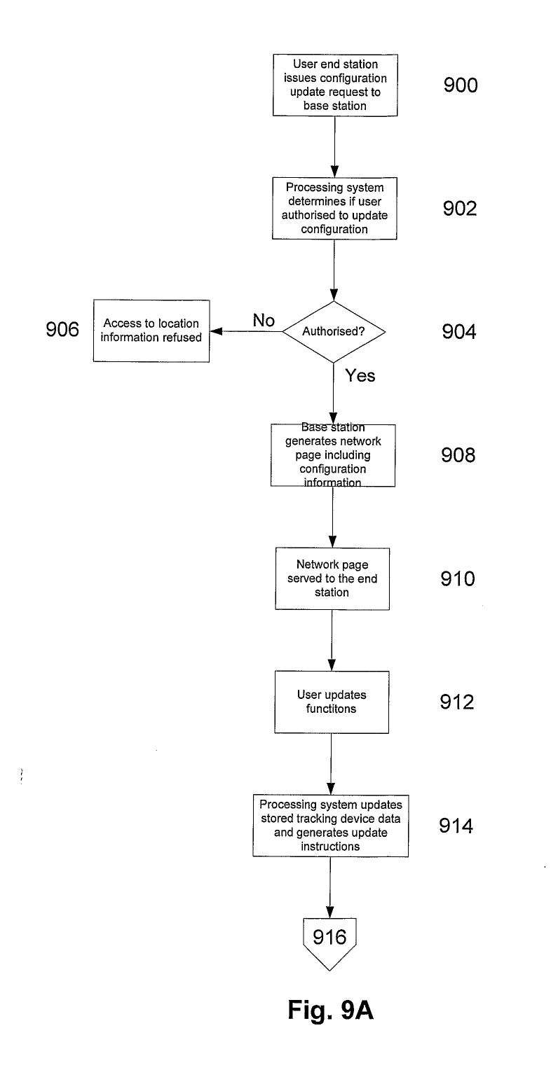

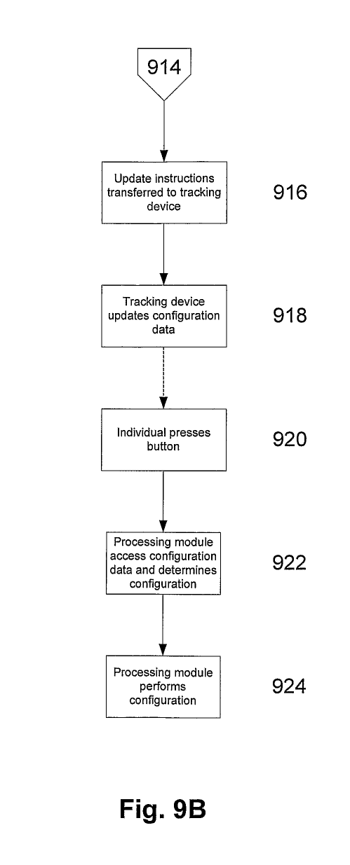

An example process for updating settings associated with the tracking device will now be described with reference to FIG. 9.

In this example at step 900 a user end station 203 issues an update settings request to the base station 201. Again this can be achieved in any appropriate manner and may involve accessing a webpage, for example by selecting the “my devices” option 816 on the user interface 810. Again, as part of this process, authorisation information may again be provided, as will be appreciated by persons skilled in the art.

At step 902 the processing system 210 determines if the user is authorised to update the settings and it is determined not, at step 904, the process moves on to step 906, with access being refused. Otherwise, at step 908 the base station 201 generates a webpage displaying a user interface providing access to the settings defined in the configuration and/or tracking device data.

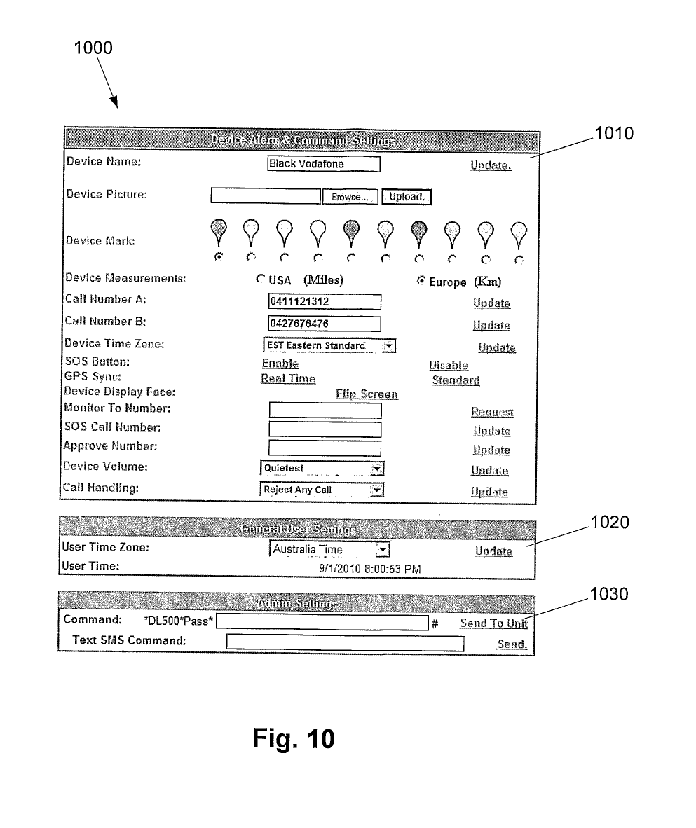

An example of the interface is shown in FIG. 10. In this example, the interface 1000 includes device alerts and command settings window 1010, a general user settings window 1020 and an admin settings window 1030 to allow users to adjust settings, such as:
a tracking device name, picture and mark that appear in the representation window 830;
call numbers associated with respective input buttons;
to activate or deactivate an SOS button;
the timing and content of reminder notifications, such as medication alerts, which can be implemented as alarms on the tracking device to indicate to the individual that medication should be taken, or other actions performed;
time and date settings;
end station numbers to which indications should be provided;
a device call volume; and,
various call handling options.

The webpage is served to the end station 203 at step 910 allowing the user to update the settings at step 912. This is typically achieved by interaction with the web page via a browser application hosted on the end station 203, as will be appreciated by a person skill in the art.

At step 914 the processing system 210 updates the tracking device data and if required generates update instructions. The update instructions are transferred to the tracking device at step 916 allowing the processing module 120 to update the configuration data stored in the memory 122.

In use, the configuration data is accessed by the processing module 120 allowing the settings of the tracking device to be modified based upon instructions from the base station 201. Thus, for example, a user can configure an input button so that if this is pressed a notification is sent to a predetermined end station 203. To achieve this when an individual presses the button at 920 the processing module 120 accesses the configuration data and determines the action associated with the button at step 922, such as providing location information to the base station, together with an indication of the button that was actuated. The processing module 120 then performs the relevant function at step 924.

In the above examples, authorisation may alternatively or additionally be performed by the tracking device 100, for example if location request or update requests are received directly from an end station 203. This can be achieved by having a list of authorised end stations 203 and/or users stored as part of the configuration data, or by having the tracking device 100 poll the base station 201 for authorisation.

In any event, it will be appreciated that the above described process allows modification of both the handling of location indications and notifications by the base station 201, as well as operation of the tracking device 100, to be performed remotely by a user. This is particularly advantageous if the tracking device is being worn by an individual that could become confused by the device operation, thereby assisting in making the device suitable for use by individuals suffering from conditions, such as dementia, or the like. In particular, the user can adjust settings of the device without requiring input from the individual. This means that the individual does not need to be involved in configuring the tracking device, and can avoid the individual inadvertently deactivating specific features. As a result, the user can be confident that the tracking device 100 is always functioning as desired.

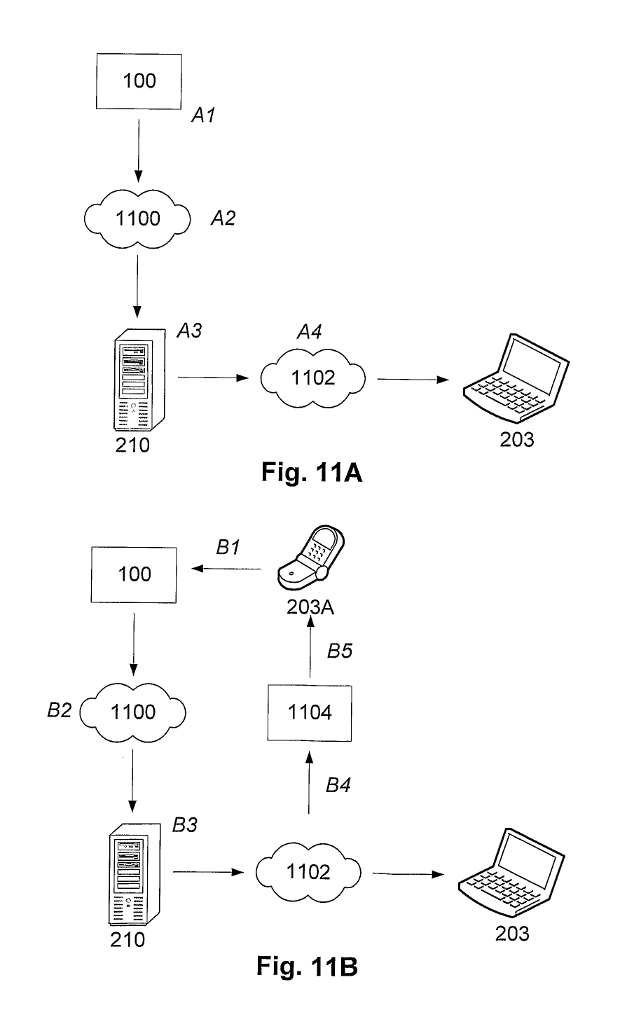

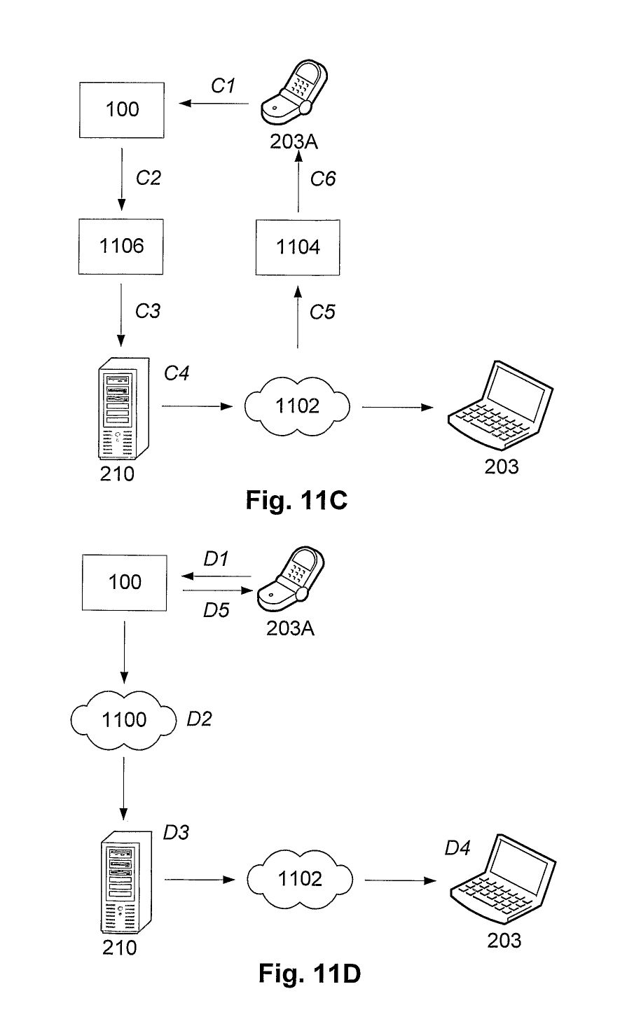

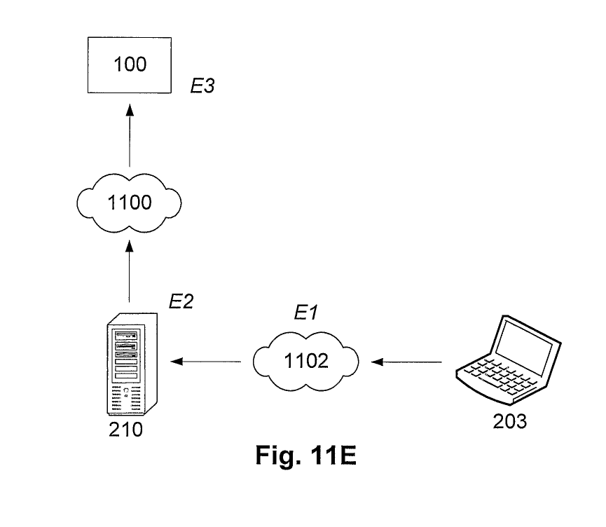

A number of example usage scenarios will now be described with reference to FIGS. 11A to 11E.

FIG. 11A shows a standard operating mode in which:
A1. The tracking device 100 searches for a GPS location every specified number of minutes.
A2. The tracking device 100 relays the location to a server, such as the processing system 210, via a GPRS network 1100.
A3. The server 210 both stores this location and translates the GPS location into mapping software.
A4. The location is made available immediately over the internet 1102 to authorized users. This is all carried out while the tracking device 100 is turned on.

In the example of FIG. 11B, the tracking system is used to locate an individual using an end station 203 in the form of a mobile phone in a functional GPRS area. In this example, the steps performed are broadly as follows:
B1. Authorised User Calls or SMS's the tracking device 100 from their mobile phone 203A.
B2. The tracking device 100 relays its position via the GPRS network 1100 to the server 210.
B3. The server 210 updates the location indication on the webpage.
B4. The server 210 contacts an SMS gateway 1104 with the position details now supplied with both Lon/Lat location and the closest available street location.
B5. The SMS gateway 1104 contacts the authorised user's mobile phone 203A with an SMS containing the latest position as a local street address and a long/lat location.

In the example of FIG. 11C, the tracking system is used to locate an individual using an end station in the form of a mobile phone in an SMS coverage only area. In this example, the steps performed are broadly as follows:
C1. Authorised user calls the tracking device 100 from their mobile phone 203A.
C2. The tracking device 100 checks the user is authorised to get the information and checks its status, checking whether it has a GPRS connection, if it does not then it will send an SMS containing the details to the an SMS Gateway 1106.
C3. Incoming SMS gateway 1106 sends the details to the server 210.
C4. The server 210 updates the user's webpage.
C5. The server 210 contacts an SMS gateway 1104 with the position details now supplied with both Lon/Lat location and the closest available street location.
C6. Outgoing SMS Gateway 1104 sends details to user's phone 203A.

In the example of FIG. 11D, the tracking system is used to update the configuration settings of the tracking device 100 from an authorised mobile phone. In this example, the steps performed are broadly as follows:
D1. SMS sent from authorized mobile phone 203A to the tracking device 100.
D2. The tracking device 100 makes the requested changes and sends details on to the server 210.
D3. The server 210 stores and reflects those changes in the tracking device data.
D4. The changes can then be observed via authorised users connected via the internet 1102.
D5. The tracking device 100 sends SMS back to authorized phone 203A confirming the action is completed.

In the example of FIG. 11E, the tracking system is used to locate or update the tracking device via a webpage. In this example, the steps performed are broadly as follows:
E1. Web User logs in with username and password using the end station 203.
E2. The server 210 updates tracking device data.
E3. Update instructions are sent via the GPRS network 1100, with the tracking device 100, responding to server to confirm the configuration data is updated successfully.

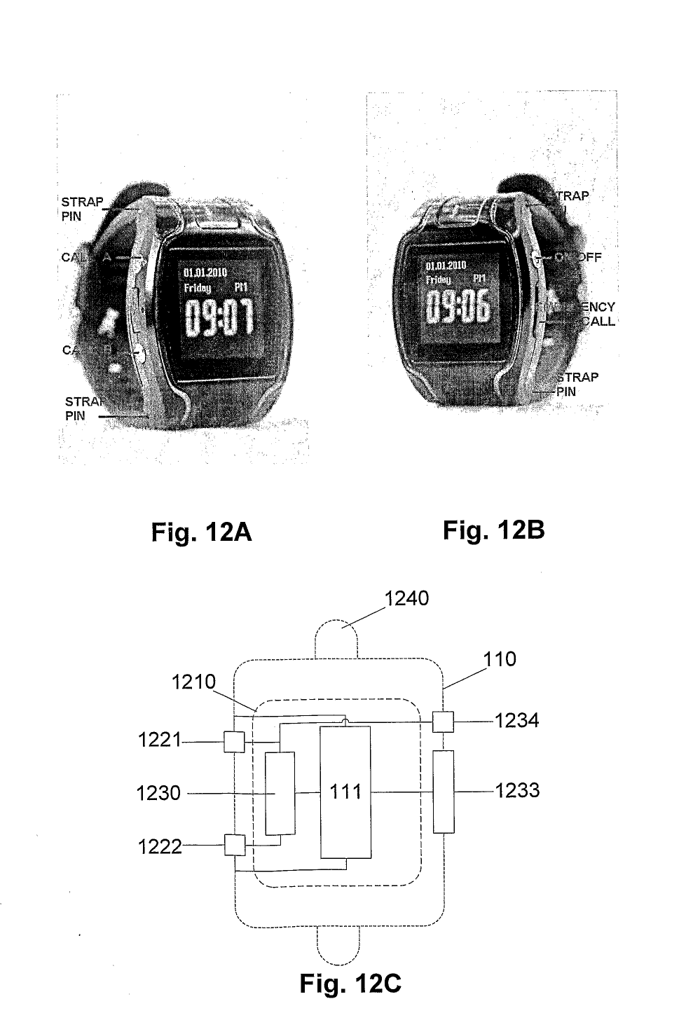

A specific example tracking device is shown in FIGS. 12A and 12B. As shown the tracking device 1200 has the appearance of a watch, including a screen 1210, such as the display 151, three input buttons 1221, 1222, 1223, and a power button 1224, corresponding to the buttons 152. In one example, the input button 1223 forms an SOS button that is used to signify that the individual requires immediate attention. In addition the buttons 1221, 1222 are electrically connected to a battery 1230 used as the device power supply. This allows the 1221, 1222 buttons to be used as contacts, allowing a current to be supplied to the battery, thereby allowing the battery to be charged without being removed from the device. Additionally, by using a suitable current source, such as an additional battery pack, this can be used to allow the battery to be charged without removing the tracking device from the individual.

A strap 1240 allows the tracking device 100 to be worn as a normal watch, presenting an indication of the current time on the display screen 1210. The display screen can also be used to present status information regarding the operation of the device, such as a battery charge level, a communications signals strength, determined from the communications module or the like. In one example, one of the buttons 1221, 1222 can be programmed to cause the time to be presented to the individual wearing the watch in audible form, for example using programmed speech presented via a speaker 153.

The strap 1240 may also include a locking buckle, which can only be undone using two hands. This prevents individuals removing the tracking device themselves, thereby avoiding individuals willfully removing the device.

It will be appreciated that the above described system provides can be used to provide a watch with additional features, including a GPS receiver and a phone, built in. The device is designed so that should a person with an intellectual disability go missing then a command from an authorised mobile phone can be used to cause an SMS to be returned containing the wearer's current street address. A map showing the location may also be optionally sent. The SMS and map can be sent from a web based server that translates the lon/lat position provided by the GPS system, to a physical address.

The device can contain an interchangeable battery that can be easily swopped by a carer or other individual. The phone can contains also an emergency panic alarm and 2 preprogrammed phone numbers that are user selectable. Alternatively these buttons can be disabled depending on the wearers level of disability. The device can be used to provide geo-fencing at differing levels and in one example can only be removed with both hands (to stop them removing it themselves) or can be worn as a standard watch for someone of a frail nature. The interaction between the users can be via SMS for commands to control the unit or via a web interface which is accessible with a password by emergency services or authorised users. The device will also act as a stand phone for incoming calls. In one example, the device looks like a watch but can also convert to a pendant and a broach easily.

The device can therefore act as a Personal Emergency Response System that includes GPS tracking, a cellular mobile phone/data connection, as well as watch with associated reminder functions, such as medication reminders, that connects via the mobile phone/data connection to a translation & data storage server.

The operation of the tracking device typically includes checking incoming commands received via SMS/Phone, and checking whether that is from an authorized source. If so, the command is carried out, and if not it is rejected. In contrast, incoming internet based commands are carried out as the server user needs a user & password to send the command. Authorised users also include the dedicated incoming SMS & outgoing SMS phone numbers.

The can tracking device include three input buttons providing the ability to call three chosen phone numbers, two of which it just calls, the third of which acts as an emergency call, but can also be used to trigger contact with nominated users, for example by SMS and e-mail notifications.

The tracking device can contain a GPS receiver that relays the position when connected to the internet across to the application/data server at specified intervals. The unit can also gave activated a geofence that sets an alarm when the user leaves a predetermined area, along with the ability to set off an alarm when a predetermined speed is exceeded.

The unit can also contain a reminder function that can be programmed up to alert the wearer at predetermined times to remember to perform certain actions, such as taking medication.

This is particularly useful for individuals suffering from dementia, who often lose track of actions that are required, such as taking of medication. In one example, this is achieved by having a user programme the alarms with a predetermined message, allowing the message to be presented to the individual wearing the tracking device 100, either as textual information presented via the display 151, or as audible information presented via the speaker 153. Thus, for example, the tracking device could generate a notification “it is now time to take your medication”, thereby reminding the individual of the respective action that needs to be performed.

Transmission of location information and other alerts is typically carried out by the server through its software and also through the SMS Gateway. The server converts the Long/Lat location details and converts them also to a street address, which is then posted on a webpage that contains a map showing the street address location along with both the long/lat and speed. If the user wishes then this page can also have a photograph of the user for identification purposes.

These details can also sent by SMS to a mobile phone via an outgoing SMS gateway. Such SMS notifications can also contain a link to the map accessible over mobile internet. The server can also send these details by e-mail to other authorized users, depending on the configuration of the system.

The server can also store all movements and transactions between the units and the server so these can be accessed for identification and tracing purposes. These movements can be overwritten after a predetermined amount of time so as to avoid excessive data buildup.

In one example, each user of the system can have two passwords, one providing access to the display page and basic location functions, the second to allow the user to alter settings on that tracking device. It can either be transmitted via mobile internet or by dedicated outgoing SMS (is also an authorized user on the list of authorized users for that unit).

The ability to track an individual's location can assist to save lives yet can also reduce health care costs, increase quality of life and reduce costs to the community (Police, Search & Rescue and Social services). The technology also gives the carer or minder the ability to monitor and communicate with any person wearing the tracking device, anywhere around the world, wherever a mobile phone or Internet connection will work.

The system can also be configured to generate notifications as required, so for example it can remotely monitor the location and movement of an individual, as well as operating parameters of the tracking device, and generate notifications as required. In particular, carers or minders will receive an immediate alert on their mobile phone whenever any of the pre-defined parameters are exceeded. The notification can include critical information such as the exact location of the individual. Cares or minders can preselect contact phone numbers as well as critical ranges which include distance & boundaries.

In addition to this, location information can be provided in the form of maps that can provide additional information, such as details of the terrain in which the individual is located, as well as providing maps and pictures of different scales to assist with locating the individual. It will be appreciated that maps may be manipulated for additional information and clarity.

The system also allows for a photograph of the individual wearing the tracking device to be distributed, thereby assisting third parties, such as emergency services, in identifying the individual.

It will be appreciated that the system can be used in a wide range of circumstances and can be used to provide peace of mind in respect of:
Children.
Corporate and Personal Security.
Travel Security.
Safety—Medical Alert.
Reporting emergencies—Fire, Disaster.
Tracking movement and speed

Persons skilled in the art will appreciate that numerous variations and modifications will become apparent. All such variations and modifications which become apparent to persons skilled in the art should be considered to fall within the spirit and scope of the invention broadly appearing and described in more detail herein.

It is to be appreciated that reference to “one example” or “an example” of the invention is not made in an exclusive sense. Accordingly, one example may exemplify certain aspects of the invention, whilst other aspects are exemplified in a different example. These examples are intended to assist the skilled person in performing the invention and are not intended to limit the overall scope of the invention in any way unless the context clearly indicates otherwise.

Features that are common to the art are not explained in any detail as they are deemed to be easily understood by the skilled person. Similarly, throughout this specification, the term “comprising” and its grammatical equivalents shall be taken to have an inclusive meaning, unless the context of use clearly indicates otherwise.

1. A tracking system for tracking the location of an individual, the tracking system including a tracking device worn by the subject in use, the tracking device including a processor for:
a) determining a tracking device location; and,
b) transferring location information indicative of the tracking device location to a base station via a communications network, the base station being for:
i) generating a location indication indicative of the tracking device location using the location information; and,
ii) providing the location indication to at least one user via a user end station and a communications network.

2. The tracking system according to claim 1, wherein the tracking device includes at least one input button, and wherein in response to actuation of the at least one input button, the processor is for:
a) initiating communication with at least one user end station;
b) transferring location information to the base station; and,
c) transferring status information to the base station.

3. The tracking system according to claim 1, wherein the tracking device includes at least one input button, and wherein in response to actuation of the at least one input button, the processor is for:
a) determining an action associated with the at least one input button using configuration data stored in a store; and,
b) performing the action in accordance with the configuration data.

4. The tracking system according to claim 1, wherein the tracking device is for:
a) receiving update instructions from at least one of the base station and a user end station; and,
b) updating configuration data in accordance with the function instructions.

5. The tracking system according to claim 4, wherein the processor is for:
a) receiving update instructions from a user end station;
b) determining if the user end station is authorised to update configuration data; and,
c) updating the configuration data in accordance with a successful determination.

6. The tracking system according to claim 1, wherein the processor is for transferring location information at least one of:
a) periodically;
b) in response to actuation of an input button; and,
c) in response to a location request from at least one of the base station and a user end station.

7. The tracking system according to claim 1, wherein the processor is for:
a) transferring the location information using a first communications process if the first communication process is available; and,
b) transferring the location information using a second communications process if the first communications process is not available.

8. The tracking system according to claim 7, wherein the first communications process includes transferring the location information to the base station using a data transfer protocol, and wherein the second communications process includes transferring the location information to a messaging gateway using a messaging protocol, the messaging gateway transferring the location information to the base station.

9. The tracking system according to claim 1, wherein the location information includes an indication of a tracking device identifier.

10. The tracking system according to claim 1, wherein the processor is for:
a) determining status information indicative of a device status; and,
b) transferring the status information to the base station, the base station being responsive to the status information to determine any actions required.

11. The tracking system according to claim 10, wherein the status information is indicative of:
a) received location requests;
b) input buttons actuated; and,
c) device operating parameters.

12. The tracking system according to claim 1, wherein the tracking device includes:
a) a body containing processing electronics; and,
b) a strap for attaching the body to the individual.

13. The tracking system according to claim 12, wherein the strap is lockable to prevent the tracking device being removed by the individual.

14. The tracking system according to claim 1, wherein the tracking device includes at least two input buttons.

15. The tracking system according to claim 14, wherein the at least two input buttons are electrically connected to a battery, the at least two input buttons forming electrical contacts to allow a current to be applied to the battery thereby charging the battery.

16. The tracking system according to claim 1, wherein the tracking device includes:
a) a location module for determining the tracking device location;
b) a communications module for communicating with at least one of the base station and a user end station; and,
c) a processing module including the processor for:
i) determining the tracking device location from the location module; and,
ii) transferring the location information to the base station using the communications module.

17. The tracking system according to claim 16, wherein the location module is a GPS module, and the location information includes latitude and longitude information.

18. The tracking system according to claim 16, wherein the communications module includes a cellular communications module.

19. The tracking system according to claim 1, wherein the tracking device includes a speaker and microphone for allowing voice communication using the communications module.

20. A tracking system for tracking the location of an individual, the tracking system including, a base station including a processor for:
a) receiving location information from a tracking device worn by the individual via a communications network, the location information being indicative of a tracking device location;
b) generating a location indication indicative of the tracking device location using the location information; and,
c) providing the location indication to at least one user via a user end station and a communications network.

21. The tracking system according to claim 20, wherein the location information is indicative of a latitude and longitude, and wherein the processor is for:
a) determining an address using the latitude and longitude; and,
b) generating the location indication using the address.

22. The tracking system according to claim 20, wherein the location indication includes a graphical representation of the address.

23. The tracking system according to claim 20, wherein the location information includes an indication of a tracking device identifier, and wherein the processor is for storing location data indicative of the tracking device location in a store using the tracking device identifier.

24. The tracking system according to claim 20, wherein the processor is for:
a) determining a recipient; and,
b) transferring the location indication to the recipient.

25. The tracking system according to claim 20, wherein the processor is for determining the recipient using at least one of:
a) tracking device data stored in a store;
b) a tracking device identifier; and,
c) status information received from the tracking device.

26. The tracking system according to claim 20, wherein the processor is for:
a) determining if a user is authorised to receive the location indication; and,
b) providing the location indication in response to a successful authorisation.

27. The tracking system according to claim 20, wherein the processor is for:
a) receiving status information from the tracking device; and,
b) at least one of:
i) determining any actions required using status information; and,
ii) storing the status information.

28. The tracking system according to claim 20, wherein the status information is indicative of:
a) received location requests;
b) input buttons actuated; and,
c) device operating parameters.

29. The tracking system according to claim 20, wherein the processor is for:
a) comparing at least one of status information and location information to defined criteria; and,
b) selectively providing at least one of location indication and a notification to a user end station in response to the results of the comparison.

30. The tracking system according to claim 20, wherein the base station is for:
a) determining update instructions; and,
b) transferring the update instructions to the tracking device, the tracking device being responsive to the update instructions to update configuration data.

31. The tracking system according to claim 30, wherein the base station is for determining update instructions in accordance with user input commands received from a user end station.

32. The tracking system according to claim 20, wherein the processor is for at least one of:
a) storing the location information in a store;
b) transferring the location indication to the user end station; and,
c) allowing the user end station to access a network page including the location indication.

33. A tracking system for tracking the location of an individual, the tracking system including:
a) a tracking device worn by the subject in use, the tracking device including a device processor for:
i) determining a tracking device location; and,
ii) transferring location information indicative of the tracking device location to a base station via a communications network; and,
b) a base station including a base station processor for:
i) receiving location information from a tracking device worn by the individual via a communications network, the location information being indicative of a tracking device location;
ii) generating a location indication indicative of the tracking device location using the location information; and,
iii) providing the location indication to at least one user via a user end station and a communications network.

34. (canceled)

35. A method of tracking the location of an individual, the method including in a processor of a tracking device worn by the subject in use:
a) determining a tracking device location; and,
b) transferring location information indicative of the tracking device location to a base station via a communications network, the base station being for:
i) generating a location indication indicative of the tracking device location using the location information; and,
ii) providing the location indication to at least one user via a user end station and a communications network.

36. A method for use in tracking the location of an individual, the method including in a processor of a base station:
a) receiving location information from a tracking device worn by the individual via a communications network, the location information being indicative of a tracking device location;
b) generating a location indication indicative of the tracking device location using the location information; and,
c) providing the location indication to at least one user via a user end station and a communications network.

37. A method for tracking the location of an individual, the method including:
a) in a processor of a tracking device worn by the subject in use:
i) determining a tracking device location; and,
ii) transferring location information indicative of the tracking device location to a base station via a communications network; and,
b) in a base station processor:
i) receiving location information from a tracking device worn by the individual via a communications network, the location information being indicative of a tracking device location;
ii) generating a location indication indicative of the tracking device location using the location information; and,
iii) providing the location indication to at least one user via a user end station and a communications network.
